(19) United States
(12) Patent Application Publication
(10) Pub. No.: US 2014/0013881 A1
(43) Pub. Date: Jan. 16, 2014

(54) METHOD FOR SYNCHRONIZING A DOUBLE CLUTCH TRANSMISSION AND DOUBLE CLUTCH TRANSMISSION

(71) Applicants: Eckhardt Luebke, Friedrichshafen (DE); Bernard Hunold, Friedrichshafen (DE)

(72) Inventors: Eckhardt Luebke, Friedrichshafen (DE); Bernard Hunold, Friedrichshafen (DE)

(73) Assignee: ZF Friedrichshafen AG, Friedrichshafen (DE)

(21) Appl. No.: 14/006,831

(22) PCT Filed: Feb. 2, 2012
(86) PCT No.: PCT/EP12/51769

§ 371 Date: Sep. 23, 2013

(30) Foreign Application Priority Data
Mar. 24, 2011 (DE) 10 2011 006 004.9

(51) Int. Cl. F16H 3/08

(52) U.S. Cl. CPC F16H 3/08
USPC 74/331

(57) ABSTRACT

A method of synchronizing a double clutch transmission having two input shafts and an output shaft. The input shafts can couple a motor drive shaft via an input friction clutch to synchronize rotation of the forward gears. The input shafts are coaxial with one located within the other, and the transmission output shaft is likewise coaxial. Each of the forward and reverse gears are arranged in a respective gearset plane. The gear clutches for the forward and reverse gears form gear shifting devices with some being actuated on two sides. Progressive gear steps are realized between the forward gears, and the gear clutches are unsynchronized shift elements. The rotational speed of one or more gear clutches, necessary for a gear change, is adapted as needed by actuating one or both of the input clutches and controlling the rotational speed of the motor.

This application is a National Stage completion of PCT/EP2012/051769 filed Feb. 2, 2012, which claims priority from German patent application serial no. 10 2011 006 004.9 filed Mar. 24, 2011.

### FIELD OF THE INVENTION

The invention relates to a method for synchronizing a double clutch transmission, and a double clutch transmission.

### BACKGROUND OF THE INVENTION

Double clutch transmissions that have friction clutches arranged at the input side and are each connected by an input shaft to a group of uneven or even gears and constitute two subtransmissions with a common output shaft are known in various designs. The two friction clutches can for example be designed nested in a compact double clutch unit, the two input shafts being arranged coaxially one upon the other. One input shaft is designed as an exterior, shorter hollow shaft out of which the other input shaft extends as a longer, inner solid shaft. Alternately, two individual clutches can also be arranged in an axially parallel arrangement of two input shafts. The output shaft can be arranged differently.

The shifting operations of such a transmission are sequential, wherein the next gear is preselected in the currently load-free transmission train such that two gears are simultaneously engaged, and the gear change transitions from one gear to the next gear while largely retaining traction, by an overlapping disengagement and engagement of the two friction clutches.

Double clutch transmissions are capable of meeting the requirements of commercial vehicle transmissions to enable start-off and maneuvering processes under heavy vehicle loads on gradients, or during difficult road conditions, and also enable fast and efficient driving during long-distance haulage and therefore require a relatively large overall gear ratio spread. Known multi-group transmissions for commercial vehicles are more likely to have geometrical gear steps with approximately equal step changes, the difference of the maximum speeds varying between the gears, and they achieve the requirements by having a high number of gears, typically 12 or 16 gears, in a combination of two or three individual transmissions; however, double clutch transmissions can have a comparable overall spread with fewer gears due to their self-contained design, and are more likely to have progressive gear steps with varying step changes, and the difference of the maximum speeds scarcely changes between the gears. The sequential shifting of double clutch transmissions is traction-supported per se, whereas multi-group transmissions require additional effort for traction-supported gear changing with a largely optional shifting sequence.

A nine gear double clutch transmission is known from DE 10 2005 005 942 A1 with progressive step changes that has a relatively large overall spread. Provided therein are a first gear as a crawler gear, a second gear as a start-off gear, a seventh gear as a direct gear, as well as two useful overdrive gears for full load haulage in which the maximum speed is not reached. The nine forward gears are achieved with seven gear set planes. A reverse gear can be coupled to one of the gear set planes of the forward gears. Overall, 10 gear clutches are arranged for shifting gears, partially in clutch devices that can be actuated from two sides.

DE 10 2007 049 270 A1 discloses a double clutch transmission having at least eight power-shiftable forward gears. On each of both sides of a main shaft arrangement, the transmission has a countershaft arrangement. The two countershaft arrangements are arranged axially parallel to each other. The main shaft arrangement comprises two transmission input shafts arranged coaxially over each other, which are each connected to an input-side friction clutch and one output shaft arranged coaxially upstream therefrom. The eight forward gears, as well as one or two reverse gears, are configured in five gear set planes and one output step, and can be shifted with eight gear clutches as well as one additional shifting element. At least one gear is designed as a winding path gear that can be shifted via the additional shifting element by means of which the two transmission input shafts can be coupled to each other.

With double clutch winding transmissions, the flow of power of one or more gears alternates over a number of gear planes to between the main shaft arrangement and a parallel countershaft arrangement. The flow of power therefore winds through the transmission. In comparison to conventional transmission structures, winding transmissions manage with fewer pairs of gears, or gear set planes, to generate a specific number of gears; however, the flow of power runs through numerous components.

For synchronizing the rotational speed in the shifting operations of double clutch transmissions, synchronization units are provided that can be actuated on two sides or at least one side. However, in comparison to simple form-locking claw clutches, synchronization units are more complex and expensive. Consequently, double clutch transmissions with unsynchronized shifting elements have already been proposed. However, measures for adapting the rotational speed are required to shift gears in such a transmission.

A synchronization method for a double clutch transmission with unsynchronized gear clutches is known from DE 102 32 837 A1. The transmission comprises a double clutch consisting of two separate friction clutches that are arranged axially parallel and are drive-connected with each other. One input shaft is assigned to each of the two friction clutches, and the double clutch transmission has a common, axially parallel output shaft arranged between the input shafts. Idler gears that are arranged on the input shafts are connectable in a rotationally fixed manner to the shafts by means of claw couplings and engage with assigned fixed gears on the output shaft, whereby two subtransmissions are formed. Each fixed gear forms a transmission ratio alternatingly with an idler gear of one input shaft or the other input shaft. Gear shifting occurs in the normal, sequential manner for double clutch transmissions in which a subsequent gear is preselected in the presently load-free subtransmission and while the other subtransmission is within the flow of power. By overlapping the disengagement and engagement of the two friction clutches, the torque is smoothly transferred without an interruption in tractive force from one subtransmission to the other. To synchronize the shifting clutch of the respective subsequent gear in the load-free subtransmission, the previously open associated friction clutch of the subtransmission is operated in slip mode until achieving the necessary adaptation of speed of the shift dogs to be engaged. Then the subsequent gear can be engaged, and the gear shifting can be executed as described.

### SUMMARY OF THE INVENTION

Against this background, the object of the invention is to present a method for synchronizing the speed in shifting procedures in a double clutch transmission with a comparatively large number of gears. In addition, a double clutch transmission of the initially-cited type is proposed that enables such a method to be performed and can be manufactured comparatively economically and constructed in a compact manner.

The invention is based on the knowledge that all the upshifting and downshifting of a double clutch transmission can be synchronized by variable use of both clutches and suitable engine speed guidance. Accordingly, a compact double clutch transmission with more than eight gears can have a branching flow of power for winding path gears, and can possess gear sets that yield at least partially progressive gear steps to realize a comparatively high overall gear ratio spread, and nevertheless be equipped with economical unsynchronized claw shift elements. A double clutch transmission that enables such synchronization of rotational speed of more than eight gears can be realized by suitably arranging fixed and idler gears in an interactive system of hollow shafts and solid shafts in a main shaft and a parallel idler shaft.

The invention is accordingly based on a method for synchronizing a double clutch transmission with two transmission input shafts and one transmission output shaft, wherein the two transmission input shafts are each connectable to a driveshaft of a drive motor by means of an assigned input-side friction clutch, wherein gears are arranged in a plurality of gear set planes and are designed as idler gears or fixed gears and are each connected in a rotationally fixed manner to one of the two transmission input shafts or to a shaft that is drive-connectable thereto, or are pivoted thereto, wherein gear clutches are assigned to the idler gears by means of which the idler gears are connectable in a rotationally fixed manner to the relevant shaft, and the rotational speed is adapted by means of one or more of the gear clutches.

The stated problem regarding the method is solved according to the invention in that an adaptation of the rotational speed of one or more of the gear clutches necessary for a gear change is performed as needed by means of actuating one or both of the input side friction clutches and controlling the rotational speed of the drive motor.

In one embodiment of the method, a speed adaptation is performed as needed to shift nine forward gears by means of six gear set planes and eight unsynchronized gear clutches in which the load-free friction clutch of the two friction clutches is engaged when upshifting, and the load-transmitting friction clutch of the two friction clutches is operated in slip mode when downshifting, and/or the load-free friction clutch of the two friction clutches is engaged.

Furthermore, the invention is based on a double clutch transmission with two transmission input shafts and one transmission output shaft, wherein the two transmission input shafts are each connectable to a driveshaft of a drive motor by means of an assigned input-side friction clutch, wherein gears are arranged in a plurality of gear set planes and are designed as idler gears or fixed gears and are each connected in a rotationally fixed manner to one of the two transmission input shafts or to a shaft that is drive-connectable thereto, or are rotatable thereto, wherein gear clutches are assigned to the idler gears by means of which the idler gears are connectable in a rotationally fixed manner to the relevant shaft.

In order to solve the stated problem regarding the double clutch transmission, the invention proposes designing a transmission structure for shifting at least nine forward gears, wherein the two transmission input shafts are arranged coaxially one over the other, and the transmission output shaft is arranged coaxially behind them, wherein the gears of the forward gears are arranged in six gear set planes, wherein the gears of a reverse gear are arranged in a separate gear set plane, wherein at the most eight gear clutches for the forward gears, and one gear clutch for the reverse gear, are arranged in gear shifting devices that are partially actuatable on two sides, wherein at least partially progressive gear steps are realized between the forward gears, and wherein the gear clutches are designed as an unsynchronized shift elements.

Progressive gear steps are to be understood as gear steps that sequentially vary.

This transmission has a particularly compact design by combining the arrangement of the two friction clutches into one nested double clutch unit, wherein the two input shafts are arranged coaxially one over the other, and the transmission output shaft is arranged coaxially behind them, and by a transmission structure in which the gears are predominately mounted for rotation as shiftable idler gears on shaft segments that can be coupled with each other. This enables nine to ten gears with only six gear set planes and eight gear clutches. A plurality of the gears, especially the lower gears, can be realized as winding path gears.

With nine or ten gears in this arrangement, an overall gear ratio spread can be achieved with progressive gear steps that is comparable to a group transmission with a much higher number of gears, and that satisfies the requirements of a transmission for a commercial vehicle, such as a truck in long-distance haulage. This enables easy and reliable startup, even with a full load on gradients, as well as efficient long-term operation. The ninth gear can be designed as a direct gear. The transmission structure also enables a tenth gear that preferably can be designed as a fast gear with a similar gear ratio. All gear changes can occur without interrupting the tractive force as is normally the case with double clutch transmissions.

Construction space and cost can be further saved by an embodiment of the double clutch transmission in which six of the eight gear clutches of the forward gears are combined in three gear shifting devices that can be actuated from two sides, and by another embodiment that can be successfully combined therewith in which only one gear shifting device is arranged in a large majority of the axial gaps each existing between two respective gear set planes.

In addition, an axial free space without a gear shifting device can exist between at least two of the gear set planes. This allows a support wall for mounting a shaft to be arranged there with relatively slight effort. It is, however, possible to design the individual shafts or shaft segments of the transmission structure to be short enough to dispense with an additional support wall for mounting a shaft in order to save additional cost and weight.

Significant additional advantages relative to conventional transmissions result in regard to design complexity, cost, the required construction space and weight, in particular because the rotational speed of the transmission can be synchronized by means of the method according to the invention. Accordingly, all the gears can be synchronized while upshifting and downshifting by means of motor rotational speed guidance and the double clutch. All of the shifting elements are therefore designed as a simple claw shifting elements.

In the cited embodiment of the transmission, six of the gear clutches for the forward gears can be combined in three claw shifting devices actuatable from two sides. The two other gear clutches, as well as the gear clutch for reverse gear, can be designed as individual claw shifting devices. Synchronous clutches and transmission brakes can be completely discarded.

Accordingly, starting from a set motor rotational speed, the rotational speed of the gear clutches of the target gear can be adapted by engaging the load-free clutch for all sequential upshifting and downshifting that require it. With some downshifts, it may also be necessary to guide the target rotational speed by means of the load-transmitting clutch. The load-transmitting clutch is temporarily put into slip mode as needed to enable the rotational speed of the relevant shift dogs to be adapted.

### BRIEF DESCRIPTION OF THE DRAWINGS

A drawing of an exemplary embodiment accompanies the description to illustrate the invention. Shown are:

FIG. 1 A schematic representation of a double clutch transmission,

FIG. 2 A shift pattern of the double clutch transmission according to FIG. 1 with an example of a series of transmission ratios of the gear sets and an associated step series in a table, and

FIG. 3 A synchronization diagram of the double clutch transmission according to FIG. 1 with an example of rotational speed of the transmission ratio series according to FIG. 2 in a table.

### DETAILED DESCRIPTION OF THE PREFERRED EMBODIMENTS

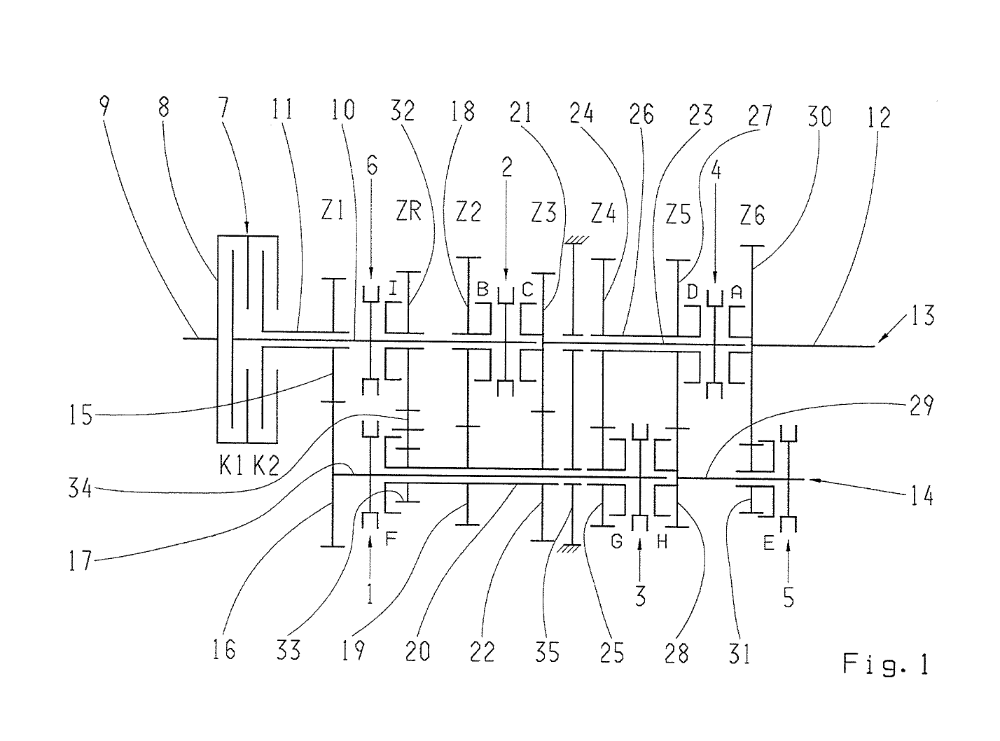

Accordingly, FIG. 1 shows a diagram of a double clutch transmission with unsynchronized shifting elements which, for example, can be provided for a commercial vehicle. A comparable double clutch transmission with synchronized shifting elements is disclosed in the unpublished DE 10 2010 030 264 A1 by the applicant.

The double clutch transmission comprises a double clutch device 7 with two input side friction clutches K1, K2 and two coaxial transmission input shafts 10, 11 that are arranged one over the other. A common clutch drum 8 of the double clutch 7 is connected to a driveshaft 9 of a drive motor (not shown). The first transmission input shaft 10 is designed as an inner, solid shaft that is concentrically guided in the second transmission input shaft 11 designed as a shorter, hollow shaft 11 out of which it extends at the transmission side. The inner transmission input shaft 10 is drive-connectable to the drive motor by means of the first friction clutch K1 close to the motor, and the outer transmission input shaft 11 is drive-connectable to the drive motor by means of the second friction clutch K2 close to the transmission.

The two transmission input shafts 10, 11 and a transmission output shaft 12 coaxially arranged therebehind form a main shaft arrangement 13. A countershaft arrangement 14 is axially parallel thereto. Arranged on the main shaft arrangement 13 and the countershaft arrangement 14 are six gear set planes Z1, Z2, Z3, Z4, Z5, Z6 for forward gears that are each formed by a pair of gears 15/16, 18/19, 21/22, 24/25, 27/28, 30/31, and one gear set plane ZR is available for a reverse gear that is formed by a trio of gears 32/33/34. The proportions of the two gears of each gear set plane are not depicted to scale.

The first gear set plane Z1 is designed as an input stage. It has a first gear 15 that is connected in a rotationally fixed manner to the second transmission input shaft 11, and a second gear 16 that meshes with this gear 15 and is connected in a rotationally fixed manner to a central counter shaft segment 17.

The second gear set plane Z2 is formed by a first gear 18 and a second gear 19. The first gear 18 is rotatably supported on the first transmission input shaft 10. The second gear 19 is arranged in a rotationally fixed manner on an outer countershaft segment 20 that is rotatably mounted as a hollow shaft on the central countershaft segment 17.

The third gear set plane Z3 possesses a gear 21 that is connected to a central main shaft segment 23 of the main shaft arrangement 13, and a gear 22 that is arranged in a rotationally fixed manner on the outer countershaft segment 20.

The fourth gear set plane Z4 possesses a gear 24 that is arranged in a rotationally fixed manner on a main shaft segment 26 designed as a hollow shaft, which in turn is rotatably supported on the central main shaft segment 23. The gear 24 engages with a gear 25 which is rotatably supported on the central countershaft segment 17.

The fifth gear set plane Z5 is formed by a gear 27 that is connected in a rotationally fixed manner to the outer main shaft segment 26, and a gear 28 that is connected in a rotationally fixed manner to an output side countershaft segment 29.

The sixth gear set plane Z6 comprises a gear 30 that is connected in a rotationally fixed manner to the transmission output shaft 12, and a gear 31 that is rotatably mounted on the countershaft segment 29.

A reverse gear set plane ZR is arranged between the first gear set plane Z1 and the second gear set plane Z2. It comprises a gear 32 that is rotatably supported on the first input shaft 10, a gear 33 that is connected in a rotationally fixed manner to the outer countershaft segment 20, as well as an intermediate gear 34 for reversing the direction of rotation.

The described system of gears and shafts can be actuated by a total of six gear shifting devices 1, 2, 3, 4, 5, 6 with nine gear clutches A, B, C, D, E, F, G, H, I designed as unsynchronized claw shifting elements. There is an arrangement of three claw clutches 2, 3, 4 actuatable from two sides and three individual claw clutches 1, 5, 6.

The first gear shifting device 1 is arranged on the countershaft arrangement 14 between the first gear set plane Z1 and the reverse gear set plane ZR. It is actuatable on one side by means of the gear clutch F for coupling the central countershaft segment 17 to the outer countershaft segment 20.

The second gear shifting device 2 is arranged on the main shaft arrangement 13 between the second gear set plane Z2 and the third gear set plane Z3. It is equipped on two sides with gear clutches B and C, and serves to couple the gear 18 of the second gear set plane Z2 to the first input shaft 10, and to couple the gear 21 of the third gear set plane Z3 and the associated central main shaft segment 23 to be first input shaft 10.

Between the third plane Z3 and the fourth plane Z4, there is an axial free space that can be used for an optional support wall 35 for mounting a shaft for the central shaft segment 23 on the main shaft plane 13 and the central shaft segment 17 on the countershaft plane 14. Such an additional gap for a bearing (not shown) of the inner transmission input shaft 10 on the main shaft plane 13, and for the outer shaft segment 20 on the countershaft plane 14 is between the reverse gear plane ZR and the second gear set plane Z2.

The third gear shifting device 3 is arranged on the countershaft arrangement 14 between the fourth gear set plane Z4 and the fifth gear set plane Z5. It can be actuated on two sides with the gear clutches G and H. It serves to couple the gear 25 of the fourth gear set plane Z4 to the central countershaft segment 17, and to couple the gear 28 of the fifth gear set plane Z5 and the associated output side countershaft segment 29 to the central countershaft segment 17.

The fourth gear shifting device 4 is arranged on the main shaft arrangement 13 between the fifth gear set plane Z5 and the sixth gear set plane Z6. This gear shifting device can be actuated on both sides by means of the gear clutches A and D. In addition, the gear 27 of the fifth gear set plane Z5 can be coupled to the inner main shaft segment 23, and the gear 30 of the sixth gear set plane Z6 and associated transmission output shaft 12 to the central main shaft segment 23.

The fifth gear shifting device 5 is downstream from the sixth gear set plane Z6 on the countershaft arrangement 14. It can be connected on one side by means of the gear clutch E to couple the gear 31 of the sixth gear set plane Z6 to the output side countershaft segment 29.

The sixth gear shifting device 6 is arranged on the main shaft arrangement 13 between the first gear set plane Z1 and the reverse gear set plane ZR. The reverse gear ZR can be actuated by means of this one-sided gear shifting device 6 with the gear clutch I that couples the gear 32 of the reverse gear set plane ZR to the first transmission input shaft 10.

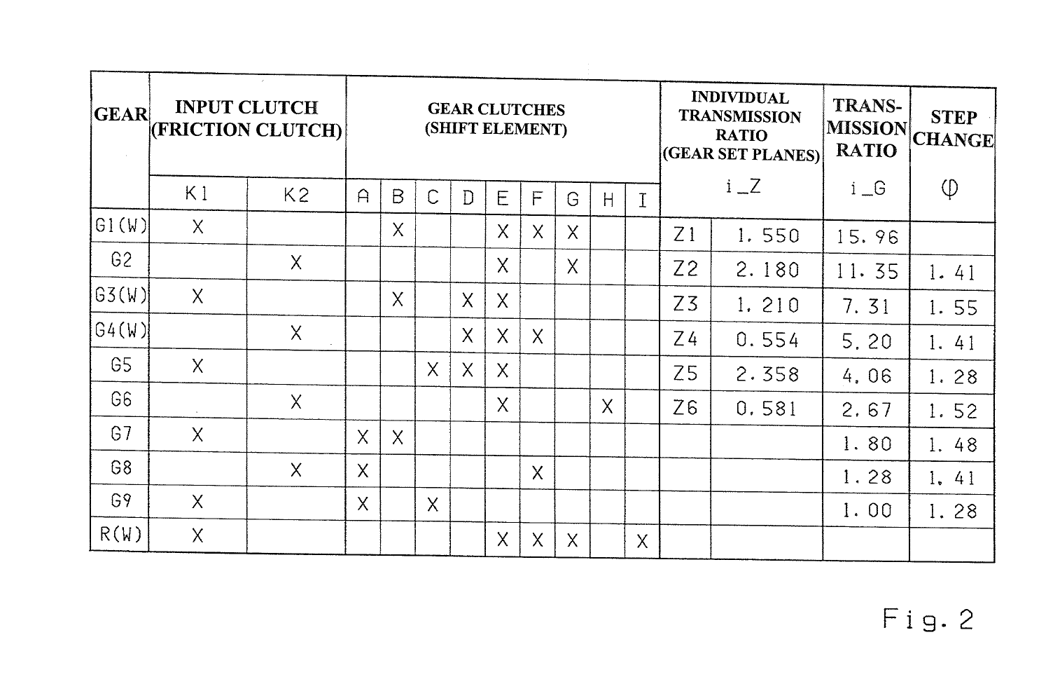

FIG. 2 shows a shift pattern of the transmission of a design with nine forward gears G1 to G9 and one reverse gear R. Ten forward gears can also be realized with this transmission structure.

From the table, it can be seen that the gears G1 to G9 can be shifted in an alternating sequence by means of the two input clutches K1, K2, wherein at least two, and a maximum of four, of the gear clutches A to I can be or are engaged. The flow of force of the gears G1, G3, G4 one, three and four, as well as the reverse gear R, proceeds several times alternatingly via the main shaft arrangement 13 and the countershaft arrangement 14. They are configured as winding path gears and are correspondingly marked in the table (G1(W), G3(W), G4(W)).

The three last columns of the table show a numerical example for a transmission ratio of the transmission. The individual transmission ratios i_Z of the gear set planes or gear sets Z1 to Z6 yield the transmission ratios i_G of gears G1 to G9 according to the shift pattern from the product of the shifted individual transmission ratios i_Z. The individual transmission ratios i_Z are each indicated as the ratio of the rotational speed of the gear arranged on the top shaft in FIG. 1 to the rotational speed of the gear arranged on the bottom shaft in FIG. 1. The associated step changes φ between the gears each result from the ratio of the transmission ratios i_G of the neighboring gears. The steps series has step changes φ that vary between φ=1.28 and φ=1.55. The transmission is accordingly stepped progressively, that is with decreasing step changes φ between the gears, although not continuously. From the ratio of the transmission ratios of the first gear i_G1=15.96 designed as a starting gear and the highest ninth gear i_G9=1 designed as a direct gear yields an overall gear ratio of i_ges=i_G1/i_G9=15.96.

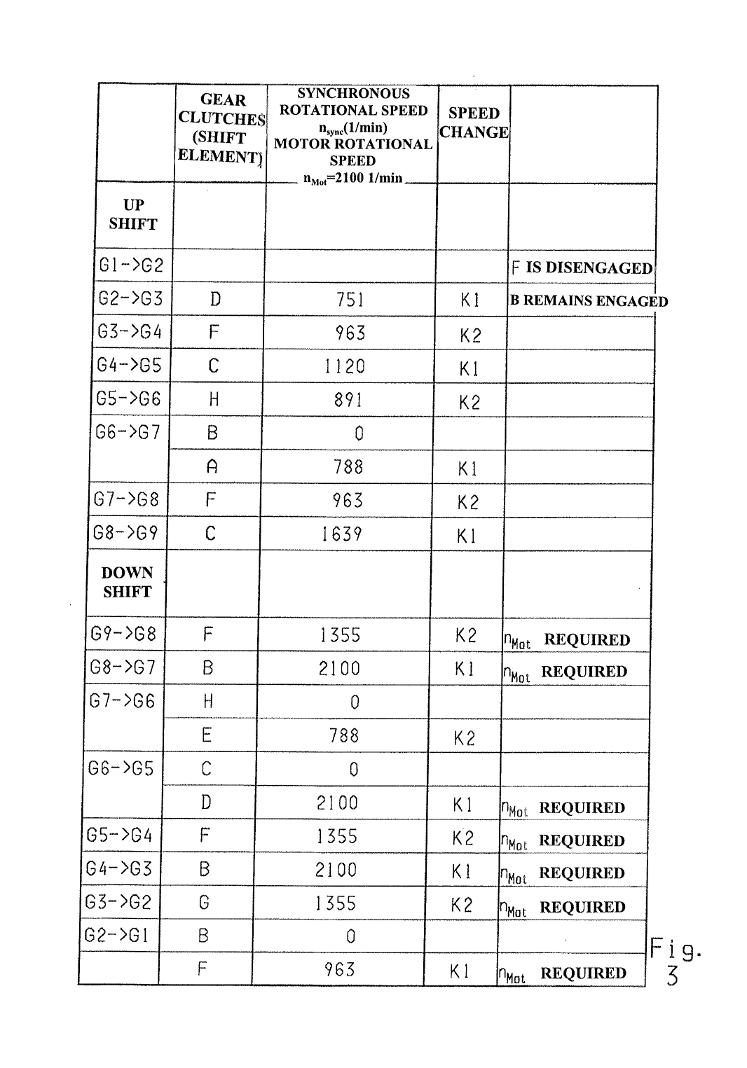

The rotational speed synchronization of this transmission is illustrated as an overview in the table in FIG. 3. As an example of a predetermined transmission input speed or drive motor speed, the following is assumed for all shift procedures: n_Mot =2100 rpm. The respective target rotational speeds n_sync of the gear clutches to be engaged or synchronized results, according to FIG. 1 and FIG. 2, from the branching of the flow of power through the individual transmission ratios of the gear set planes.

For the gear shift from the starting gear G1 to second gear G2, only a load transition of input clutches K1, K2 is required. A gear clutch F is disengaged when the load transition of the input clutches K1, K2 is over and the relevant gear clutch F has thereby become load-free. A prior adaptation of the rotational speed is unnecessary since no new gear clutches need to be engaged in the target gear G2. Another gear clutch B that also becomes load-free in the target gear G2 can usefully remain engaged since it is required again in the following third gear G3.

All of the additional sequential upshifting can be synchronized by adapting the rotational speed of each load-free input clutch K1, K2.

As an example, the shifting process will be further explained for upshifting from fourth to fifth gear G4→G5:

In the currently engaged gear G4, the second input clutch K2 transmits the load. Three gear clutches D, E, F are engaged. Two of the gear clutches D, E remain engaged for the target gear G5 to be engaged. The third gear clutch F engaged in the original gear can be disengaged load-free after the gear change. A new gear clutch C is engaged for the target gear G5. The corresponding synchronous rotational speed can be derived according to the transmission structure and shift pattern. The gear pairs 15/16 and 21/22 of the first and third gear set planes Z1, Z3. Accordingly:

$${n}_{sync} = {n}_{Mot} \cdot \frac{1}{{i}_{Z 1} \cdot {i}_{Z 3}} = 2100 \cdot \frac{1.21}{1.55} = 1639 {min}^{- 1} .$$

The rotational speed of the gear clutch C is adapted to this end value by the slipping engagement of the current load free first input clutch K1. Once the rotational speed of the shifting element driven by the input clutch K1 equals that of the corresponding shifting element on the driven gear 21 of gear clutch C, gear clutch C can be engaged. Then, the clutch K2 transmitting load in the original gear can be disengaged, and the clutch K1 transmitting load in the subsequent gear can be engaged in order to complete the shifting of the gear from fourth to fifth gear G4→G5 with no interruption in tractive force.

In the case of some downshifts, the load-transmitting input clutch is temporarily put into slip mode when engaging the load-free input clutch K1, K2, and the motor speed is adjusted to n_sync in order to bring the gear clutch to be engaged to the synchronous rotational speed. The target rotational speed in these downshifts is guided by means of the load-transmitting input clutch K1, K2.

As an example, the shifting process will be further explained for downshifting from fifth to fourth gear G5→G4:

In the currently engaged gear G5, the first input clutch K1 transmits the load.

Three gear clutches C, D, E are engaged. Two of the gear clutches D, E remain engaged in the target gear G4 to be engaged. The third gear clutch C engaged in the original gear can be disengaged load-free after the gear change. There is a new gear clutch F to shift the target gear G5. The corresponding synchronization speed of the gear clutch F is:

$${n}_{sync} = {n}_{Mot} \cdot \frac{1}{{i}_{Z 1}} = 2100 \cdot \frac{1}{1.55} = 1355 {min}^{- 1} .$$

Due to the gear clutch C drive-connected and engaged with it, the gear clutch F has an actual speed of:

$${n}_{ist} = {n}_{Mot} \cdot \frac{1}{{i}_{Z 3}} = 2100 \cdot \frac{1}{1.21} = 1736 {min}^{- 1} .$$

The speed of the relevant gear clutch F is therefore adapted by engaging the current load-free input clutch K2 and slip-controlling the current load free input clutch K1 at the regulated motor speed n_Mot. Once the relevant gear 33 reaches the same speed, the gear clutch F can be engaged. Then the clutch K1 transmitting the load in the original gear can be disengaged, and the clutch K2 transmitting the load in the subsequent gear can be engaged.

For three downshifts G7→G6, G6→G5, G2→G1 and one upshift G6→G7, two gear clutches are engaged each time in the target gear, and one of the two gear clutches is always load-free. In these cases, the load-free gear clutch is engaged first before the speed of the other gear clutch is adapted.

List of Reference Characters

1 First gear shifting device

2 Second gear shifting device

3 Third gear shifting device

4 Fourth gear shifting device

5 Fifth gear shifting device

6 Sixth gear shifting device

7 Double clutch device

8 Clutch basket

9 Driveshaft

10 Transmission input shaft

11 Transmission input shaft

12 Transmission output shaft

13 Main shaft arrangement

14 Countershaft arrangement

15 Gear

16 Gear

17 Countershaft segment

18 Gear

19 Gear

20 Countershaft segment

21 Gear

22 Gear

23 Main shaft segment

24 Gear

25 Gear

26 Main shaft segment

27 Gear

28 Gear

29 Countershaft segment

30 Gear

31 Gear

32 Gear

33 Gear

34 Gear

35 Support wall

A Gear clutch

B Gear clutch

C Gear clutch

D Gear clutch

E Gear clutch

F Gear clutch

G Gear clutch

H Gear clutch

I Gear clutch

G1 First gear

G2 Second gear

G3 Third gear

G4 Fourth gear

G5 Fifth gear

G6 Sixth gear

G7 Seventh gear

G8 Eighth gear

G9 Ninth gear

G(W) Winding path gear

K1 First input clutch, friction clutch

K2 Second input clutch, friction clutch

R Reverse gear

Z1 Gear set plane, gear set

Z2 Gear set plane, gear set

Z3 Gear set plane, gear set

Z4 Gear set plane, gear set

Z5 Gear set plane, gear set

Z6 Gear set plane, gear set

ZR Reverse gear set plain, reverse gear set

i_G Gear ratio

i_Z Individual transmission ratio, gear set plane ratio

n_Mot Motor rotational speed

n_sync Synchronous rotational speed

φ Step change

1-6. (canceled)

7. A method of synchronizing a double clutch transmission with two transmission input shafts (10, 11) and one transmission output shaft (12), the two transmission input shafts (10, 11) are each connectable to a driveshaft (9) of a drive motor via an assigned input-side friction clutch (K1, K2), gears (15, 16, 18, 19, 21, 22, 24, 25, 27, 28, 30, 31, 32, 33, 34) are arranged in a plurality of gear set planes (Z1, Z2, Z3, Z4, Z5, Z6, ZR) and designed as either idler gears or fixed gears and are each connected, in a rotationally fixed manner, either to one of the two transmission input shafts (10, 11) or to a shaft (12, 17, 20, 23, 26, 29) that is either drive-connectable thereto, or are rotatable thereto, gear clutches (A, B, C, D, E, F, G, H; I) are assigned to the idler gears by which the idler gears are connectable, in a rotationally fixed manner, to either one of the two transmission input shafts or to the shaft that is drive-connectable thereto (10, 11, 12, 17, 20, 23, 26, 29), and a rotational speed is adapted by one or more of the gear clutches (A, B, C, D, E, F, G, H), the method comprising the steps of:
adapting a rotational speed of at least one of the gear clutches (A, B, C, D, E, F, G, H), necessary for a gear change, as needed by actuating one or both of the input side friction clutches (K1, K2) and controlling the rotational speed of the drive motor.

8. The method according to claim 7, further comprising the step of shifting between nine forward gears by way six gear set planes (Z1, Z2, Z3, Z4, Z5, Z6) and eight unsynchronized gear clutches (A, B, C, D, E, F, G, H) by adapting the rotational speed, as needed, in which at least one of a load-free friction clutch of the two friction clutches (K1, K2) is engaged when upshifting, and a load-transmitting friction clutch (K1, K2), of the two friction clutches, is operated in slip mode when downshifting, and the load-free friction clutch (K1, K2) of the two friction clutches is engaged.

9. A double clutch transmission with two transmission input shafts (10, 11) and one transmission output shaft (12), the two transmission input shafts (10, 11) each being connectable to a driveshaft (9) of a drive motor by an assigned input-side friction clutch (K1, K2),
a plurality of gears (15, 16, 18, 19, 21, 22, 24, 25, 27, 28, 30, 31, 32, 33, 34) being arranged in a plurality of gear set planes (Z1, Z2, Z3, Z4, Z5, Z6, ZR) and designed as idler gears or fixed gears, and each plurality of gears (15, 16, 18, 19, 21, 22, 24, 25, 27, 28, 30, 31, 32, 33, 34) being connected, in a rotationally fixed manner, either to one of the two transmission input shafts (10, 11) or to a shaft (12, 17, 20, 23, 26, 29) that is drive-connectable thereto, or are rotatable thereto,
gear clutches (A, B, C, D, E, F, G, H; I) being assigned to the idler gears by which the idler gears are connectable, in a rotationally fixed manner, to either one of the two transmission input shafts or to the shaft that is drive-connectable thereto (10, 11, 12, 17, 20, 23, 26, 29),
a transmission structure, for shifting at least nine forward gears, being formed in which the two transmission input shafts (10, 11) arranged coaxially, one over
the other, and the transmission output shaft (12) being arranged coaxially therebehind, the plurality of gears (15, 16, 18, 19, 21, 22, 24, 25, 27, 28, 30, 31) of forward gears are arranged in six gear set planes (Z1, Z2, Z3, Z4, Z5, Z6),
gears (32, 33, 34) of a reverse gear being arranged in a separate gear set plane (ZR),
eight gear clutches (A, B, C, D, E, F, G, H) for the forward gears, and one gear clutch (I) for the reverse gear, being arranged in gear shifting devices (1, 2, 3, 4, 5, 6) that are partially actuatable on two sides, at least partially progressive gear increments are realized between the forward gears, and
the gear clutches (A, B, C, D, E, F, G, H, I) for the forward and the reverse are designed as unsynchronized shift elements.

10. The double clutch transmission according to claim 9, wherein six of the eight gear clutches (A, B, C, D, E, F, G, H), for the forward gears, are combined in three gear shifting devices (2, 3, 4) that are actuated from two sides, two of the gear clutches (A, B, C, D, E, F, G, H) of the forward gears are arranged in two gear shifting devices (1,5) that are actuated on one side, and the gear clutch (I), for the reverse gear, is arranged in a gear shifting device (6) that is actuated on one side.

11. The double clutch transmission according to claim 9, wherein only one gear shifting device (2, 3, 4) is arranged in a large majority of axial gaps (2, 3, 4) existing between each of two respective gear set planes (Z1, Z2, Z3, Z4, Z5, Z6, ZR).

12. The double clutch transmission according to claim 9, wherein an axial free space without a gear shifting device, arranged for a support wall (35) for a shaft bearing, is between at least two gear set planes (Z1, Z2, Z3, Z4, Z5, Z6, ZR).

13. A method of synchronizing a double clutch transmission having two transmission input shafts (10, 11) and one transmission output shaft (12), the two transmission input shafts (10, 11) are each connectable to a driveshaft (9) of a drive motor by an assigned input-side friction clutch (K1, K2), a plurality of gear wheels (15, 16, 18, 19, 21, 22, 24, 25, 27, 28, 30, 31, 32, 33, 34) are arranged in a plurality of gear set planes (Z1, Z2, Z3, Z4, Z5, Z6, ZR) and each of the a plurality of gear wheels is designed as either an idler gear or a fixed gear and is connected in a rotationally fixed manner either to one of the two transmission input shafts (10, 11) or to a further shaft (12, 17, 20, 23, 26, 29) that is drive-connectable thereto, or is pivotable thereto, a plurality of gear clutches (A, B, C, D, E, F, G, H; I) are engageable to connect the idler gears in a rotationally fixed manner to an associated one of the two transmission input shafts, the transmission output shaft and the further shafts (10, 11, 12, 17, 20, 23, 26, 29), the method comprising the steps of:
actuating at least one of the input side friction clutches (K1, K2) and controlling a rotational speed of the drive motor, as needed, in order to adapt a rotational speed of at least one of the plurality of clutches (A, B, C, D, E, F, G, H) for a gear change.
